(19) United States
(12) Patent Application Publication
(10) Pub. No.: US 2010/0044598 A1
(43) Pub. Date: Feb. 25, 2010

(54) Terahertz Laser Components And Associated Methods

(75) Inventor: James Hayden Brownell, Greenville, DE (US)

Correspondence Address: LATHROP & GAGE LLP, 4845 PEARL EAST CIRCLE, SUITE 201, BOULDER, CO, 80301, US

(73) Assignee: The Trustees of Dartmouth college

(21) Appl. No.: 12/605,938

(22) Filed: Oct. 26, 2009

Related U.S. Application Data
(63) Continuation-in-part of application No. 10/529,343, filed on Mar. 25, 2005.
Application No. 10/529,343 is a continuation-in-part of application No. 12/089,878.
(60) Provisional application No. 60/414,119, filed on Sep. 27, 2002.
(60) Provisional application No. 60/700,619, filed on Jul. 19, 2005.

(51) Int. Cl. G21K 5/04

(52) U.S. Cl. 250/504 R

(57) ABSTRACT

Systems and methods for generating terahertz radiation include a pair of optical horns, each of which forms a gap at respective vertices thereof. The first horn is ruled such that an electron beam interacting with a grating period produces terahertz radiation. The horns are diametrically opposed to one another such that radiation exiting the first horn enters the second horn through the gaps. Systems and methods for generating terahertz radiation include generating and focusing an electron beam adjacent a vertex of an optical horn that is ruled with a grating period. Interaction between the electron beam and the grating period produces the terahertz radiation. A method of evaluating interaction between a material and terahertz radiation includes passing a sample of the material through the radiation. At least one of an effect of the radiation on the material, and an effect of the material on the radiation, is measured.

### RELATED APPLICATIONS

This application is a continuation-in-part of U.S. application Ser. No. 10/529,343, filed Mar. 25, 2005 as a United States National Stage Entry of PCT application PCT/US03/30566, filed Sep. 26, 2003, which claimed the benefit of priority to U.S. Application No. 60/414,119, filed Sep. 27, 2002. This application is also a continuation-in-part of U.S. application Ser. No. 12/089,878, filed Apr. 10, 2008 as a United States National Stage Entry of PCT application PCT/US06/028066, filed Jul. 19, 2006, which claimed the benefit of priority to U.S. Application No. 60/700,619, filed Jul. 19, 2005. All of the above-identified applications are incorporated herein by reference in their entireties.

U.S. Patent Application Publication No. US 2002/0097755 A1 and U.S. Pat. Nos. 5,263,043, 5,790,585 and 6,991,927 are incorporated herein by reference in their entireties.

### GOVERNMENT LICENSE RIGHTS

The U.S. Government has certain rights in this invention as provided for by the terms of Grant No. DAAD 19-99-1-0067 awarded by the Army Research Office, and Grant No. ECS-0070491 awarded by the National Science Foundation.

### BACKGROUND

Humans have developed extensive technology to generate and detect electromagnetic waves or vibrations throughout the electromagnetic spectrum—from the short wavelengths and high frequencies of gamma rays to the long wavelengths and low frequencies of radio waves. The exception to this technological know-how occurs within the far infrared (“FIR”) or terahertz gap, which exists roughly between infrared light and millimeter wavelength microwaves, although there is some overlap with the infrared and millimeter wave spectra. This gap is identified by electromagnetic energy having frequencies in the range of about 100 GHz to 30 THz, which corresponds to free space wavelengths of about 10 to 3000 micrometers (μm). In the FIR gap, various sources and detectors exist but they are not practical, e.g., they lack intensity, frequency-tuning ability and/or stability.

The most successful terahertz sources, to date, utilize the Smith-Purcell (S-P) effect, which can be viewed as the scattering of an electron's evanescent wake field from a grating. The wavelength (λ=2πc/ω) of the emitted radiation is dependent on the grating period (l), electron velocity (ν), and emission angle relative to the beam direction (θ), by the so called S-P relation:

$$λ = \frac{l}{m} ( \frac{c}{υ} - cos θ ) , \qquad ( Eq . 1 )$$

where m is the diffraction order of the emission. This relation has been confirmed for spontaneous S-P radiation experiments spanning the visible, infrared, THz, and microwave spectra.

The S-P effect was first utilized in terahertz lasers during the 1980's by the late Professor John Walsh at Dartmouth College and others. Radiation sources were developed to produce electromagnetic radiation at terahertz frequencies in a tunable fashion. The devices utilized planar diffraction gratings and showed that small, compact and relatively inexpensive tabletop free electron lasers could be commercially practiced devices for the generation of FIR electromagnetic waves. See, e.g., U.S. Pat. Nos. 5,263,043 and 5,790,585, each of which is hereby incorporated by reference.

WO 2004/038874, which is hereby incorporated by reference, disclosed improvements to terahertz radiation sources, where the planar diffraction gratings utilized by Walsh were replaced by grating horns. The grating horns confined and focused the electron beam to provide terahertz radiation with improved power output.

### SUMMARY

In one embodiment, a system for generating terahertz radiation includes first and second optical horns, each of which forms a gap at respective vertices thereof. The first horn is ruled with a grating period such that an electron beam interacting with the grating period produces terahertz radiation. The horns are diametrically opposed to one another such that radiation exiting the first horn enters the second horn through the gaps.

In one embodiment, a method for generating terahertz radiation, includes generating an electron beam and focusing the electron beam adjacent a vertex of an optical horn that is ruled with a grating period. Interaction between the electron beam and the grating period produces the terahertz radiation.

A method of evaluating interaction between a material and terahertz radiation includes generating the terahertz radiation by passing an electron beam adjacent to a vertex of a first optical horn such that the electron beam interacts with one or more gratings of the first optical horn to produce the terahertz radiation. At least a portion of the terahertz radiation passes through a gap at the vertex of the first optical horn, into a corresponding gap at a vertex of a second optical horn, such that the portion of the terahertz radiation forms a terahertz radiation beam traveling outwardly from the vertex of the second optical horn. A sample of the material passes through the terahertz radiation. At least one of an effect of the terahertz radiation on the material, and an effect of the material on the terahertz radiation, is measured.

### BRIEF DESCRIPTION OF THE FIGURES

FIG. 1 schematically illustrates one Smith-Purcell Free Electron Laser.

FIG. 2 depicts an exemplary relation between power and beam current for the grating within the Smith-Purcell Free Electron Laser of FIG. 1.

FIG. 3 depicts an exemplary planar grating horn, in accord with an embodiment.

FIG. 4 depicts an exemplary grating horn, in accord with an embodiment.

FIG. 5 depicts graphs of radiated power vs. beam current for an array of planar grating horns.

FIG. 6 depicts graphs of radiated power vs. beam current for a 20° grating horn and for a planar grating horn.

FIGS. 7-13 depict multiple exemplary grating horns, in accord with embodiments.

FIG. 14 depicts an exemplary system for interacting particles with coherent radiation.

FIGS. 15-19 schematically show multiple exemplary embodiments with two optical horns that are diametrically opposed to one another.

FIG. 20 schematically shows an exemplary embodiment with two optical horns that are diametrically opposed to one another, and a mirror forming a resonant cavity with one of the optical horns, according to an embodiment.

FIG. 21 schematically shows an exemplary embodiment with two optical horns that are diametrically opposed to one another, one of the optical horns forming a resonant cavity with a mirror, within a chamber that is separated from the second horn by a window, according to an embodiment.

FIG. 22A schematically shows a backward wave oscillator including two diametrically opposed grating horns and configured as an intracavity absorption spectrometer, according to an embodiment.

FIG. 22B is a schematic cross-sectional view of the backward wave oscillator of FIG. 22A.

FIG. 23 schematically shows a another backward wave oscillator containing two diametrically opposed optical horns and configured as an absorption spectrometer, according to an embodiment.

### DETAILED DESCRIPTION

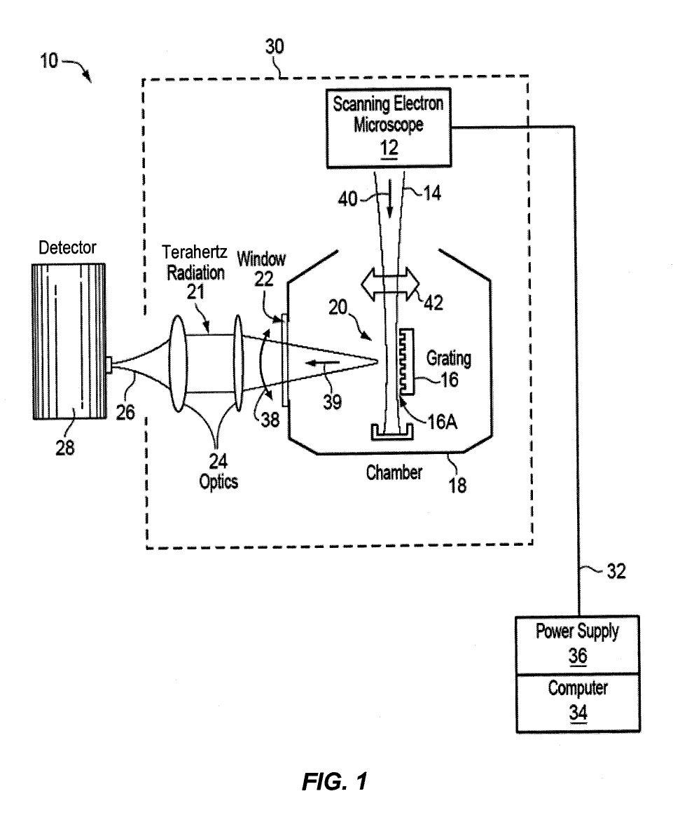

FIG. 1 depicts one embodiment of a free electron laser (FEL) 10. A scanning electron microscope (SEM) 12 generates an electron beam 14. A grating 16 (illustratively mounted on a specimen stage within a specimen chamber 18) is positioned at the beam focus 20 of electron beam 14. Terahertz radiation 21 scatters from grating 16 and exits chamber 18 through a window 22 that is, for example, made from polyethylene. It should be noted that “terahertz radiation” is utilized herein to mean electromagnetic energy with free space wavelengths of about 10 to 3000 micrometers (μm), irrespective of the exact frequency of such radiation. Optics 24 (e.g., a pair of TPX (tetramethyl-1-pentene) lenses that exhibit optical refraction characteristics to terahertz radiation 21) may be used to focus radiation 21 into a laser beam 26. FIG. 1 also illustratively shows a detector 28 (e.g., a bolometer) that may be used to detect radiation of laser beam 26.

The size of grating 16 may affect the overall size of laser 10, which may for example be formed into a hand-held unit 30 attached by an umbilical 32 (e.g., containing electrical wiring and data busses) to a computer 34 and power supply 36. For example, power supply 36 operating within a range of 10-100 kV (ν/c=0.1-0.7) may be used to accelerate electron beam 14 to grating 16.

An emission angle 38 of terahertz radiation 21 is for example about 20 degrees about a normal to grating 16; this produces terahertz radiation 21 that is continuously tunable over a wavelength range of 1.5 to 10 times the grating period (on a first order basis, as described below). Coverage may be extended by blazing the grating for higher orders and/or mounting several gratings of different periods on a rotatable turret (i.e., a plurality of gratings, each of the plurality of gratings rotatable to beam focus position 20 and having a different periodicity).

Certain advantages may be appreciated by laser 10 as compared to the prior art. For example, laser 10 may be made as a portable unit 30 so that users can easily use laser 10 within desired applications. In another example, laser output 26 from laser 10 may be tunable, narrowband, polarized, stable, and have continuous or pulsed spatial modes. See, e.g., J. E. Walsh, J. H. Brownell, J. C. Swartz, J. Urata, M. F. Kimmitt, Nucl. Instrum. & Meth. A 429, 457 (1999), incorporated herein by reference.

The evanescent field from beam 14 decays exponentially with distance from the electron beam's trajectory (i.e., along direction 40) with an e-folding length equal to λν/2πc for non-relativistic beam energy. In one embodiment, therefore, the electrons of beam 14 pass within the e-folding length of the surface 16A of grating 16, so that the field strength is sufficient to scatter terahertz radiation 21, as shown. Reflection from grating surface 16A back onto the electrons of beam 14 may also provide laser amplification feedback, so that gain is sensitive to beam height 42 above grating 16. For a 30 kV beam 14, the e-folding length is sixteen micrometers for 1 THz (300 micrometer) radiation 21. This in turn causes stringent requirements on the diameter of electron beam 14; and this constraint is tighter for shorter wavelengths (i.e., less than 300 μm). Accordingly, laser interaction may be optimized through resonator design and beam focusing, as now discussed.

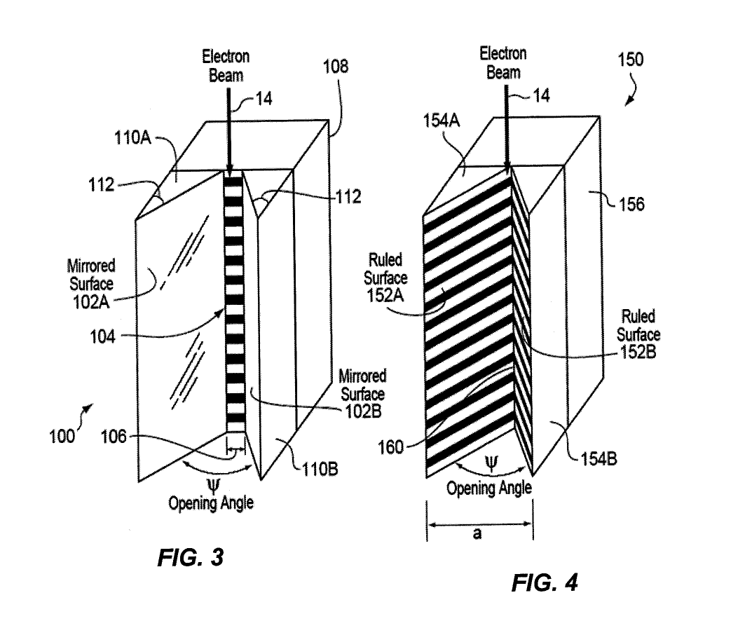

In one embodiment, grating 16 has a planar grating cut into the top of an aluminum block one centimeter long and a few millimeters wide to form a laser resonator, as in FIG. 3. See also, e.g., J. Urata, M. Goldstein, M. F. Kimmitt, A. Naumov, C. Platt, J. E. Walsh, Phys. Rev. Lett. 80, 516 (1998), incorporated herein by reference. With this configuration, there need not be mirrors or other external optics involved. In particular, electromagnetic energy travels slowly enough along grating 16 to grow significantly from grating feedback alone.

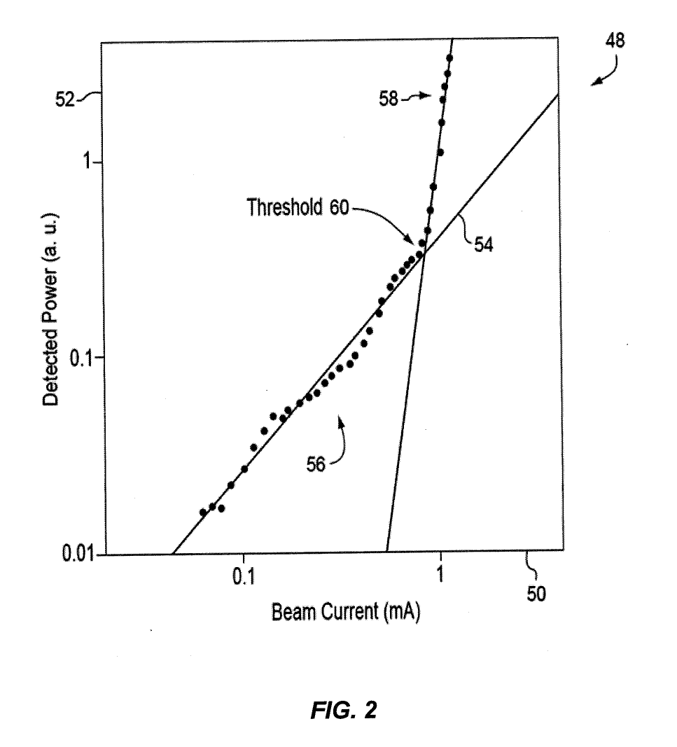

To illustrate this point, radiated power may be plotted against the beam current, as shown by graph 48 of FIG. 2, which shows a typical measurement for a planar grating. See, A. Bakhtyari, J. E. Walsh, J. H. Brownell, Phys. Rev. E 65, 066503 (2002), which is incorporated by reference herein. In FIG. 2, x-axis 50 represents beam current while y-axis 52 represents detected power. As shown in graph 48, the coupling strength grows with current and so output power also rises monotonically with current. The proportionality between current and power (slope=1, as shown by line 54) indicates spontaneous emission while a super-linear response implies amplification. The signature of a gradual rise 56 followed by a steep rise 58 indicates a laser threshold 60. In FIG. 2, the data at 0.5 THz was produced with 29 kV and a relatively broad 40 micrometer diameter beam 14. Using a planar grating 16 described above, the performance yielded 1 microwatt power and 1.5 THz.

The wiggle evident in the sub-threshold region (i.e., along gradual rise 56) is likely caused by beating between coexistent waves on grating 16. See, e.g., Bakhtyari et al., 2002. This observation confirms the physical basis for the gain mechanism; these wiggles would not appear unless significant loss occurred, the primary source of loss being radiation 21. Other loss may be reduced by enclosing the resonator with roof and walls, such as in traveling-wave tubes at microwave frequencies. But, in so doing, some tunability may be sacrificed. Therefore, closure of the resonator is not usually beneficial. Other remedies for loss are to enhance the gain (as discussed above) and to improve output coupling.

The pattern of radiation 21 varies as the cosine squared of the azimuthal angle, normal to the beam direction 39 (see FIG. 1). See also, P. M. van den Berg, J. Opt. Soc. Am. 63, 1588 (1973), incorporated herein by reference. Given that optics 24 generally collect radiation 21 within a relatively small azimuthal range of angles (e.g., emission angle 38), focusing radiation 21 as it leaves grating surface 16A will magnify the collectible intensity; but it is nonetheless preferable that the focusing elements do not disturb the dispersion described by the S-P relation of Equation 1 or else the power spectrum will be diffuse and brightness will diminish.

One solution (a grating horn antenna as in FIG. 4) is based on a horn antenna. See, C. A. Balanis, Antenna theory, analysis and design, 2nd ed., John Wiley, New York, 1997, Section 13.3, incorporated herein by reference. A “horn” is the flared end of a hollow waveguide that enlarges the effective mode area in order to reduce diffraction effects. The waveguide then transmits or receives free propagating waves more efficiently. One horn has a linear flare forming, in the case of a rectangular waveguide, a pyramidal shape of four intersecting planes. The pertinent dimensions are the width of the horn's mouth (a) and its full opening angle (ψ). If the width of the inlet is smaller than the wavelength, then a near diffraction limited light beam is directed along the horn's bisecting axis with full divergence angle φ≈sin⁻¹ (4λ/ a) for sufficiently large a. Increasing the inlet width increases φ, reduces magnification, and adds complicated structure to the radiation lobe.

The minimum spread, and therefore the greatest magnification of the peak intensity (i.e., peak horn directivity), occurs when the diffraction angle equals half the opening angle. This implies a constraint on the length (d) from the throat to the opening of the horn:

d∃2λ/tan(ψ/2)sin(ψ/2) (2)

The input power is independent of ψ so peak intensity varies inversely with the opening angle. The maximum magnification is then limited by the greatest practical horn depth.

FIG. 3 depicts one planar grating horn (PGH) 100. In the example of FIG. 3, PGH 100 has two planar intersecting mirrors 102A, 102B, with specified opening angle ψ therebetween, and a grating 104 embedded in the crease, parallel to the axis of intersection. The spacing 106 between mirrors 102A, 102B at the grating surface is usually less than one wavelength to provide optimal magnification, simple emission lobe structure, and minimal divergence angle φ for a given horn length d. Mirrors 102A, 102B of PGH 100 can fold the full emission lobe into the range of opening angle ψ, thereby enhancing the emitted intensity without altering the longitudinal angular dispersion expected from grating 104. The expected magnification over PGH 100 is then the ratio of the opening angle ψ to 180 degrees. In addition, mirrors 102A, 102B can maintain independent components of polarization, TM (radial electric field) and TE (azimuthal electric field).

The S-P interaction of Equation 1 generates mainly TM polarization and so PGH 100 functions like an H-plane sectoral horn (see Balanis, 1997). To construct PGH 100, grating 104 was ruled first in a suitable metal block 108. A pair of wedged blocks 110A, 110B (each with a wedge angle 112) with polished inner surfaces (forming mirrors 102A, 102B, respectively) were clamped so as to contact the surface of grating 104 separated by at least the width of electron beam 14. The opening angle of PGH 100 is then twice the wedge angle 112.

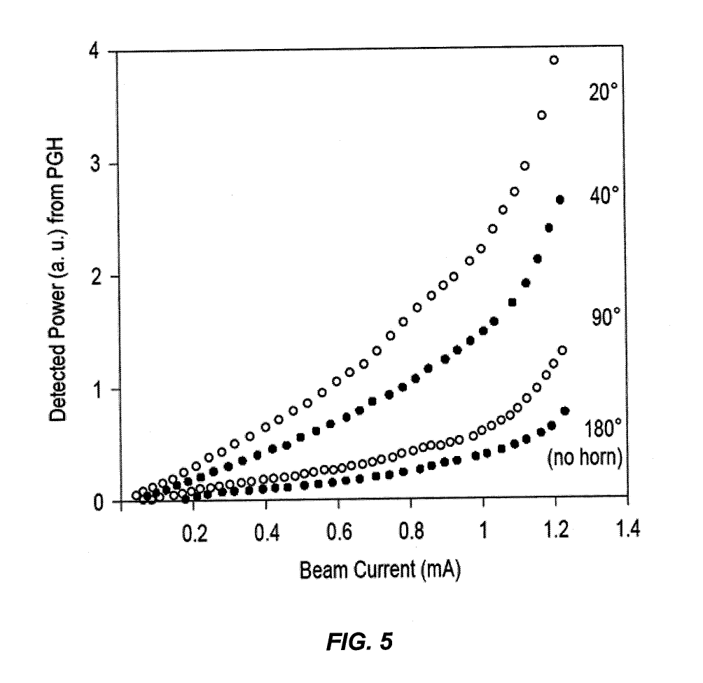

PGH 100 may for example incorporate opening angles ψ of 20, 40, 90, and 180 degrees (i.e., no horn) under similar beam conditions; other angles ψ may be chosen as a matter of design choice. To ease beam alignment during experimental testing, the separation between horn walls was 800 micrometers (20% wider than a wavelength). The results are shown in FIG. 5 with the opening angle indicated for each case (the electron beam 14 used in the testing of FIG. 5 was 29 kV with a beam waist of 58 μm). The measured power ratios for the first three cases of 6, 4, and 1.6 relative to the planar grating are 70% to 90% of the expected values. The full collection angle of the detection system (e.g., detector 28, FIG. 1) was twelve degrees so that the measured power corresponded to the peak intensity for the larger openings. The smallest opening ψ (twenty degrees) produces a ten degree lobe (e.g., defined within angle 38, FIG. 1) so the measured power is an average over the lobe and less than the peak intensity. Since consistent alignment of beam 14 along the horn vertex was difficult to maintain, slight variations may have caused reduced magnification.

In one embodiment, the horn may also be ruled. That is, the grating may be wrapped about beam 14 to enhance the proximity of beam 14 to the grating surface, thereby improving coupling. The grating shape may also be chosen so as not to affect the S-P dispersion relation of Equation 1. Ruling the horn can combine the focusing effect of the horn with the enhanced feedback from partial closure. A ruled horn has all of the emission characteristics of the H-plane sectoral horn described above and supports evanescent modes traveling synchronously with the electron beam. The region near the horn vertex of significant evanescent field strength expands with decreasing horn opening angle. Increasing the evanescent region allows greater overlap of a circular electron distribution and electric field and improved collimation of the electron beam, both of which contribute to greater energy transfer and improved laser performance. A new structure formed in this manner is termed a grating horn (GH), such as shown by GH 150 in FIG. 4.

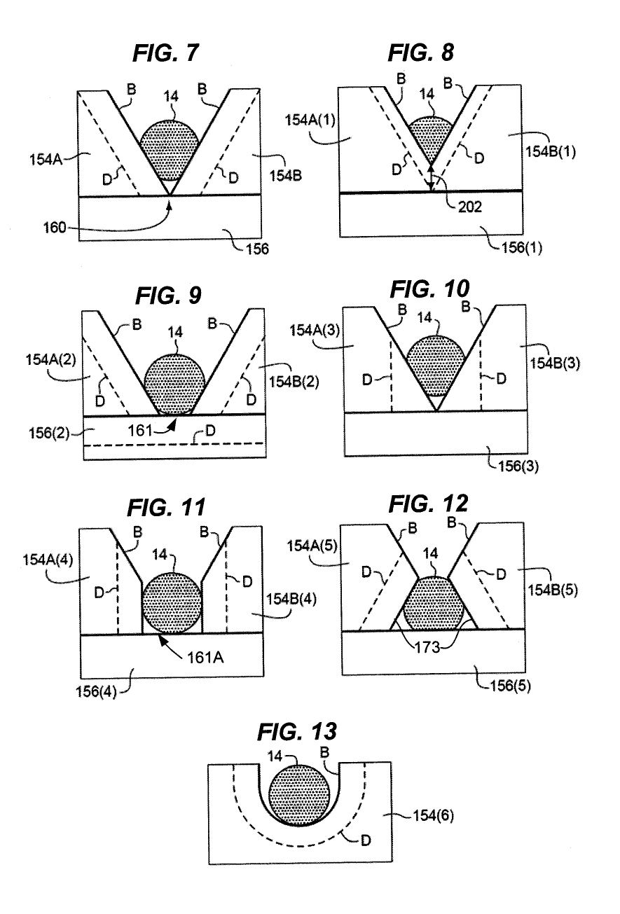

GH 150 is distinct from the shallow, gradual concavity depicted in FIGS. 16 and 7B of U.S. Pat. Nos. 5,268,693 and 5,790,585, respectively. In the latter case, the grating surface conforms to a broad, elliptical electron beam. Because the coupling strength decays exponentially away from the grating surface, spreading the beam out into a “ribbon” over a flat surface would improve the emission. But it is difficult to produce and control a spread beam. In contrast, GH 150 uses a circular beam. The primary distinction though is that GH 150 forces the electrons to interact with a single spatially-coherent field mode and generate high-brightness radiation. Regions of a spread beam separated by more than a wavelength can develop independently, thereby diminishing the overall coupling and brightness.

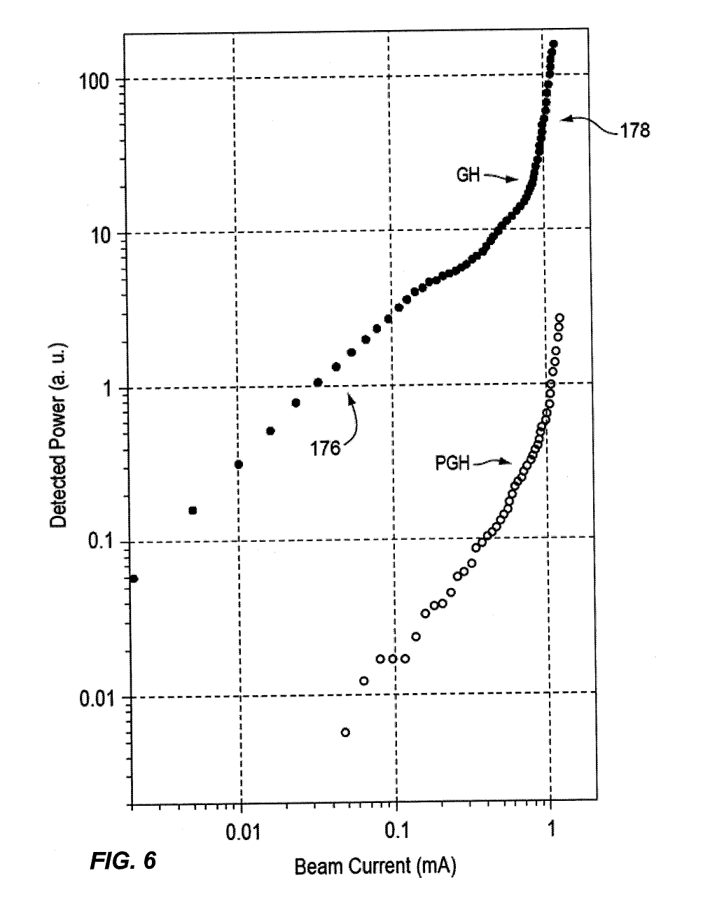

GH 150 was manufactured by ruling two planar gratings 152A, 152B on metal blocks 154A, 154B, respectively, with one side beveled at half the opening angle ψ. These blocks 154 may then be clamped to a flat base 156 with rulings of gratings 152A, 152B in contact and aligned so that the gratings are in phase. A GH with a twenty degree opening angle ψ was mounted adjacent to a planar grating (e.g., PGH 100, FIG. 3) of the same dimensions on the SEM specimen stage (i.e., in the setup of FIG. 1). Two beam current scans were conducted consecutively to ensure similar beam characteristics for proper comparison. The resulting data is plotted in FIG. 6, with power from PGH 100 as open circles and power from GH 150 as solid dots. GH 150 produced significantly higher collectable power than PGH 100, as shown. Since performance from a GH may be sensitive to the beam trajectory (i.e., the trajectory of beam 14 along direction 40), in one embodiment beam 14 follows a line parallel to a vertex 160 of GH 150 but offset along the horn bisected by roughly one beam radius. If the beam favors one side, then GH 150 acts much like PGH 100. Vertex 160 and blocks 154A, 154B form a V-groove shape through which electron beam 14 passes, as shown in FIG. 7.

Gratings 104, 152A, 152B may be formed from a wide variety of materials. In one embodiment, the material can include a conducting material, such as copper, aluminum, various alloys, gold, silver-coated conducting surfaces, or combinations thereof. Higher conductivity can enhance performance of an S-P grating. Other considerations for choosing materials include, e.g., durability; melting point and/or heat transfer, since the grating is bombarded by the electron beam; and machinability, because the grating is typically fabricated by sawing, machining, and/or laser cutting.

The output (i.e., radiation 21) from GH 150 can be similar in characteristic to PGH 100, as shown in FIG. 6 (which utilized a 29 kV beam with a 50 μm beam waist). A low-power linear regime 176 is more distinct because of the increased signal. It oscillates through a subthreshold region and abruptly rises in regime 178, similar to data shown in FIG. 5. The different shape of the oscillation likely stems from different boundary conditions in GH 150 relative to PGH 100. FIG. 6 depicts three pertinent details. First, collectable power is a multiple of at least 40 times greater with GH 150, far higher than the factor of 6 observed with the comparable PGH 100. Second, the multiple expands to 100 fold in the linear regime 176. The experiment of FIG. 6 proved that GH 150 enhanced spontaneous S-P emission as compared to PGH 100 or other gratings. Third, and most importantly, the multiple expands to 100 fold at the highest power because the threshold current of GH 150 is roughly 170 microamps lower than the planar grating. This indicates that GH 150 does indeed enhance the SP-FEL gain.

Boundary conditions largely determine the SP-FEL gain and can be altered by changing how the grating edges at vertex 160 are prepared. A wide variety of GH configurations may be used as a matter of design choice, a number of exemplary embodiments are depicted in FIGS. 7-13. These embodiments vary the degree of resonator closure and may also provide increased amplification of terahertz radiation, as for gratings 152A, 152B depicted in FIG. 4. In each case, a cross-sectional dimension of the electron beam 14 is shown, for purposes of illustration. In FIGS. 7-12, the grating is formed by teeth extending between the beveled surfaces (indicated by B) and the dotted lines (indicated by D). In FIG. 7 (which essentially shows the configuration of GH 150 tested in FIG. 6), the teeth extend from the beveled surface B to the depth D with constant depth. The beveled surfaces of blocks 154A, 154B meet at the base 156. In FIG. 8, the teeth similarly have a constant depth; however, the beveled surfaces of blocks 154A(1), 154B(1) meet at a distance 202 above the base. In FIG. 9, the teeth in the gratings of blocks 154A(2), 154B(2) similarly have a constant depth; however, blocks 154A(2), 154B(2) do not meet, as shown (accordingly, the vertex in this case includes a flat portion 161). Instead, the base 156(2) has a grating with teeth having a depth extending from B to D.

Teeth need not have constant depth, as shown, for example, in FIG. 10. Teeth can have a “triangular” or nonconstant cross section, in which the teeth have a smaller depth toward the top and a greater depth toward the base. Not shown are related embodiments, in which the blocks have triangular teeth, but the blocks either meet above the base (as in FIG. 8) or the base has a grating (as in FIG. 9). Other shapes are contemplated. FIG. 11, for example, depicts teeth having a “triangular” component and a “rectangular” component (accordingly, the vertex of this configuration is also shown with a flat portion 161A). FIG. 12 depicts an embodiment in which the teeth are ruled with constant depth on a bevel 173 having an acute angle relative to the base 156(5). Teeth can also have nonconstant depth, as described for other embodiments. In an embodiment, the gratings are aligned so that the grating element is fully symmetrical. In another embodiment, the grating elements are not symmetrical. In certain depicted embodiments, the teeth may be ruled in a direction perpendicular to the plane between the blocks 154; however, teeth may be ruled at other angles, as will be appreciated by persons of ordinary skill in the art upon reading and understanding this disclosure.

The grating element pairs of FIGS. 7-12 are typically symmetrical about a normal to a base element (e.g., blocks 154A, 154B are symmetrical about a normal to base 156). In each configuration of FIGS. 7-12, electron beam 14 interacts with the symmetrical grating element pair to produce terahertz radiation 21, as in FIG. 1. The degree of symmetry should be at least sufficient to ensure radiation 21 has the desired properties of brightness and intensity.

FIG. 13 shows one other GH having a cylindrical grating curved about the electron beam 14; this may improve coupling between beam 14 and the grating.

One advantage of GH 150 (employing, for example, a configuration grating as in FIGS. 7-13), is that the generated terahertz radiation 21 may be sufficiently collimated to avoid use of optics 24, FIG. 1, saving cost and complexity. Accordingly, in certain embodiments herein, optics 24 are not utilized in laser 10.

Additional grating embodiments are also contemplated, such as those disclosed, e.g., in U.S. Patent Application Publication No. US 2002/0097755 A1, incorporated herein by reference. The gratings may be employed in terahertz sources such as those described in U.S. Pat. Nos. 5,263,043 and 5,790,585, incorporated herein by reference. The gratings may also be utilized in terahertz sources employed in systems for studying matter, including biological matter, as disclosed in U.S. patent application Ser. No. 10/104,980, now U.S. Pat. No. 6,991,927, incorporated herein by reference.

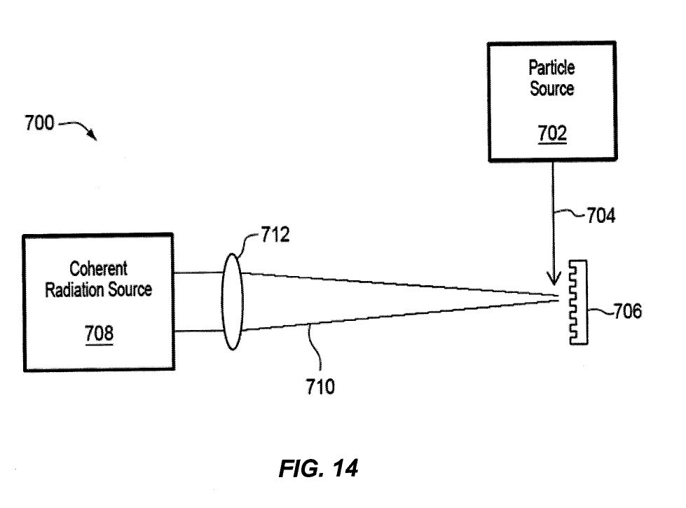

FIG. 14 shows one system for interacting particles with coherent radiation, which may be useful for example in analyzing behavior and physical interaction of the particles with the radiation. A particle source 702 (e.g., an electron generator) generates a particle beam 704 (e.g., an electron beam) towards a grating horn 706 (for example employing a configuration shown in FIGS. 7-13). A coherent radiation source 708 (e.g., laser 10, emitting laser beam 26, as depicted in FIG. 1) emits coherent radiation 710 (e.g., terahertz radiation); optics 712 optionally focus radiation 710 to grating horn 706. Beam 704 and radiation 710 then interact so as to excite, modulate and/or stimulate particles of particle beam 704. In one embodiment, the particles are electrons that are accelerated by system 700. In another embodiment, the particles are complicated structures that interact resonantly with incident radiation 710.

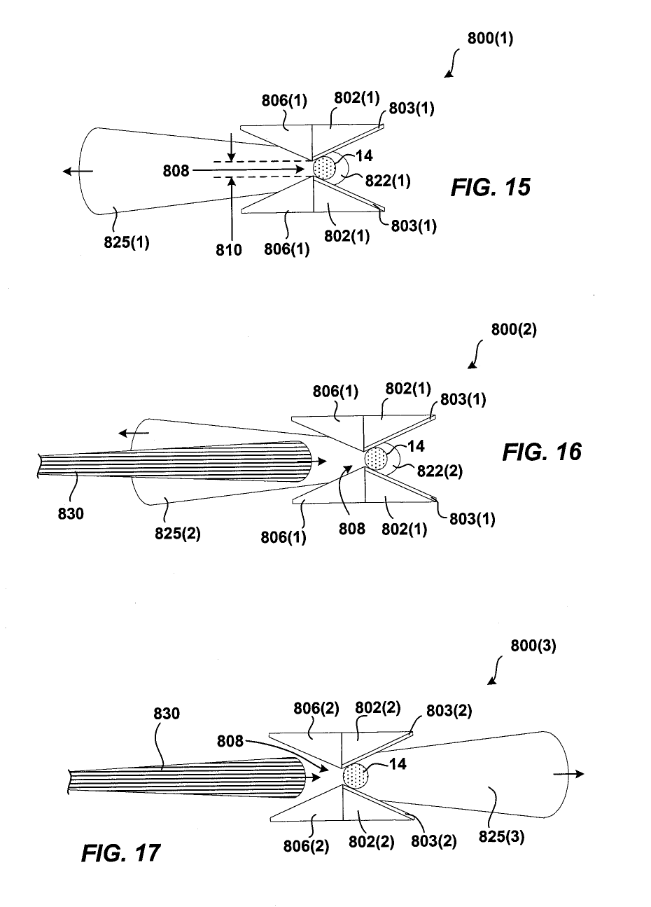

FIGS. 15-20 illustrate embodiments with first and second optical horns 802, 806 that are diametrically opposed to one another, to generate and/or manipulate terahertz radiation. In each first horn 802, a grating 803 interacts with an electron beam 14 to generate and/or manipulate terahertz radiation.

In the following drawings, terahertz radiation is depicted as a form having a shape for illustrative purposes, but it is understood that such radiation may or may not have a corresponding physical shape. Furthermore, a direction of travel of radiation is sometimes indicated by an arrow associated with the radiation, although such depiction is understood to be an abstraction, and not to suggest a physical “beginning” or “end” of the radiation.

In a dual grating horn configuration 800(1) shown in FIG. 15, a first optical horn 802(1) includes a grating 803(1), and a second optical horn 806(1) is planar. A velocity of electrons forming an electron beam 14 (traveling into or out of the plane through which FIG. 15 is taken) interacts with grating 803(1) to produce terahertz radiation in a bound mode within first horn 802(1), shown schematically as radiation 822(1). The interaction of electron beam 14 with grating 803(1) is analogous to the interaction shown in FIG. 1. Choice of electron velocity and grating period may be adjusted so that electron beam 14 interacts with a backward-wave electromagnetic mode, bound to the horn vertex region, so that first horn 802(1) functions as a backward-wave oscillator. In this condition, radiation 822(1) reflects from right to left within first horn 802(1), resulting in the bound mode shown in FIG. 15. A portion of terahertz radiation 822(1) transmits into second horn 806(1) through a gap 808 that has a width 810. Radiation 825(1) exits second horn 806(1) traveling from right to left, as shown. Adjusting width 810 of gap 808 controls intensity of radiation 825(1) emitted through gap 808. Second horn 806(1) is shown as planar in FIG. 15, but it is appreciated that horn 806(1) may be ruled with a grating and that terahertz radiation 825(1) will interact with the grating similarly to other interactions described herein. In particular, it is appreciated that horn 806(1) may act as an output coupler that emits terahertz radiation 825(1) as a collimated (e.g., diffraction limited) free wave, emitted as if from a waveguide, which may facilitate efficient coupling into instrumentation, or into further grating horns, as discussed below.

FIG. 16 shows a dual grating horn configuration 800(2) with horns 802(1) and 806(1) as shown in FIG. 15, but also with an input terahertz radiation beam 830 traveling from left to right, entering second grating horn 806(1) (e.g., beam 830 comes from a separate terahertz radiation apparatus, not shown). Configuration 800(2) may act as an amplifier or modulator of beam 830, emitting an amplified or modulated output as terahertz radiation 825(2). Terahertz radiation beam 830 enters second horn 806(1), passes through gap 808 and interacts with terahertz radiation 822(2) in the bound mode within horn 802(1), resulting in emission of radiation 825(2) back through gap 808. Like the configuration shown in FIG. 15, width 810 of gap 808 can be adjusted to control intensity of radiation 825(2) (width 810 is not labeled within FIG. 16, for clarity of illustration). Also, it is appreciated that although shown as parallel and coaxial in FIG. 16, input beam 830 need not be coaxial with radiation 825(2).

When configuration 800(2) acts as an amplifier, a (fixed) period of grating 803(1) and a (fixed) electron velocity of electron beam 14 are configured to interact at the wavelength of input beam 830. That is, the period of grating 803(1), the electron velocity and the wavelength of beam 830 are arranged to correspond as given in Eq. 1. Input beam 830, having a time-varying intensity, is projected into second horn 806(1) and a portion thereof passes through gap 808 into first horn 802(1). Input beam 830 acts to “seed” the interaction of electron beam 14 with grating 803(1), that is, by stimulating interaction between electron beam and grating 803(1) in phase with input beam 830. Power delivered by electron beam 14 to the resonant arrangement results in amplification of an intensity of input beam 830 into radiation 822(2). Since radiation 822(2) is in a bound mode near a vertex of horn 802(1) but is unconstrained at gap 808, the amplified terahertz radiation emits back through gap 808 as terahertz radiation 825(2), an amplified (and reflected) version of input terahertz radiation beam 830.

When configuration 800(2) acts as a modulator, an electron velocity of electron beam 14 is swept in accordance with a modulation signal. The modulation signal is implemented such that the combination of electron velocity and a (fixed) period of grating 803(1) interact at the wavelength of input beam 830 only at certain values of the modulation signal. When the modulation signal is such that a combination of electron velocity of electron beam 14 and period of grating 803(1) does not result in interaction at the wavelength of input beam 830—e.g., the electron velocity, period of grating 803 and wavelength of beam 830 do not satisfy Eq. 1—no amplification of input beam 830 occurs, and terahertz radiation 825(2) emits with low intensity. When the modulation signal is such that the combination of electron velocity of electron beam 14, and period of grating 803(1) do interact at the wavelength of input beam 830—e.g., the electron velocity, period of grating 803 and wavelength of beam 830 do satisfy Eq. 1—input beam 830 stimulates an increase of intensity of radiation 822(2), and terahertz radiation 825(2) emits with higher intensity. Therefore, intensity of terahertz radiation 825(2) modulates in accordance with the electron velocity in configuration 800(2). It is appreciated that varying degrees of amplification will be provided in accordance with how close the combination of electron velocity, period of grating 803(1) and wavelength of input beam 830 come to meeting the exact criterion of Eq. 1.

FIG. 17 shows a dual grating horn configuration 800(3), with horns 802(2) and 806(2), that acts as a traveling wave amplifier on an input beam 830. Like configuration 800(2), configuration 800(3) may act as an amplifier or modulator of beam 830, to produce amplified or modulated output as terahertz radiation 825(3). Configuration 800(3) performs as an amplifier or modulator in all respects like configuration 800(2) except that: (1) grating 803(2) of horn 802(2), and a position of electron beam 14, are arranged such that instead of being confined in a bound mode, terahertz radiation generated within horn 802(2) is transmitted as radiation 825(3); and (2) horn 806(2) need not be configured to both accept and radiate terahertz radiation as in configuration 800(2), rather horn 806(2) may be optimized (e.g., by setting horn angle and/or grating conditions) to accept input beam 830. Similarly to configuration 800(2), in configuration 800(3) terahertz radiation beam 830 enters second horn 806(2), and at least a portion thereof passes through gap 808 and interacts with terahertz radiation within horn 802(2), resulting in emission of amplified or modulated radiation 825(3).

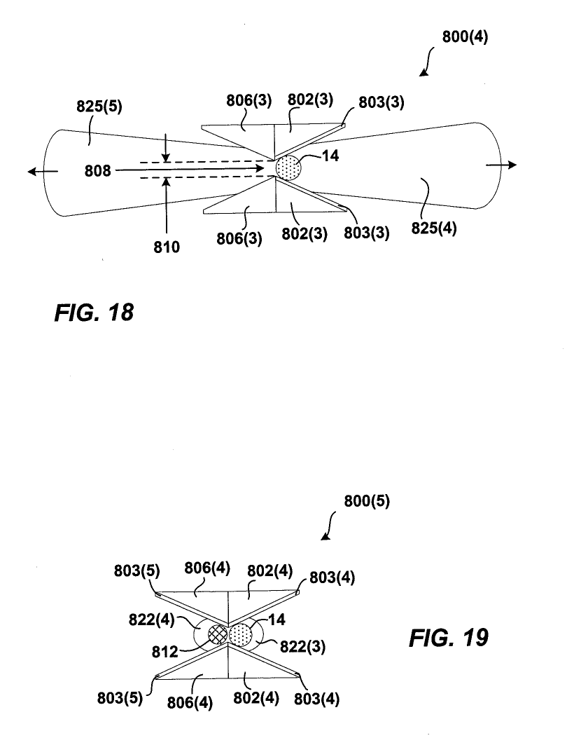

FIG. 18 shows a dual grating horn configuration 800(4) with horns 802(3) and 806(3) that emit terahertz radiation 825(4) and 825(5) in opposing directions. Interaction between a velocity of electrons in electron beam 14 and a period of grating 803(3) generates terahertz radiation, and the geometry of horn 802(3) is such that a portion of the radiation emits in a radiative mode. A width 810 of gap 808 controls how much of the terahertz radiation emits from horn 806(3) as terahertz radiation 825(5), while the rest of the terahertz radiation emits from horn 802(3) as terahertz radiation 825(4).

FIG. 19 shows a dual grating horn configuration 800(5) with horns 802(4) and 806(4). Within first horn 802(4), interaction between electron beam 14 and grating 803(4) generates terahertz radiation 822(3) in a bound mode. A portion of terahertz radiation 822(3) transmits through a gap (not labeled, for clarity of illustration) into second horn 806(4), which is configured with a grating 803(5) so as to confine the radiation as terahertz radiation 822(4) in a bound mode within second horn 806(4). An optical fiber 812 is positioned roughly parallel with electron beam 14, that is, in and out of the plane through which FIG. 19 is drawn. Terahertz radiation 822(4) couples into optical fiber 812 through frustrated total internal reflection, that is, evanescent coupling, whereupon fiber 812 may be utilized to transmit the terahertz radiation to another location. Since evanescent coupling decreases exponentially with respect to an optical fiber's distance from a source of radiation, with a decay constant on the order of the radiation's wavelength, adjusting placement of optical fiber 812 relative to horn 806(4) may be utilized to control coupling of terahertz radiation 822(4) into fiber 812.

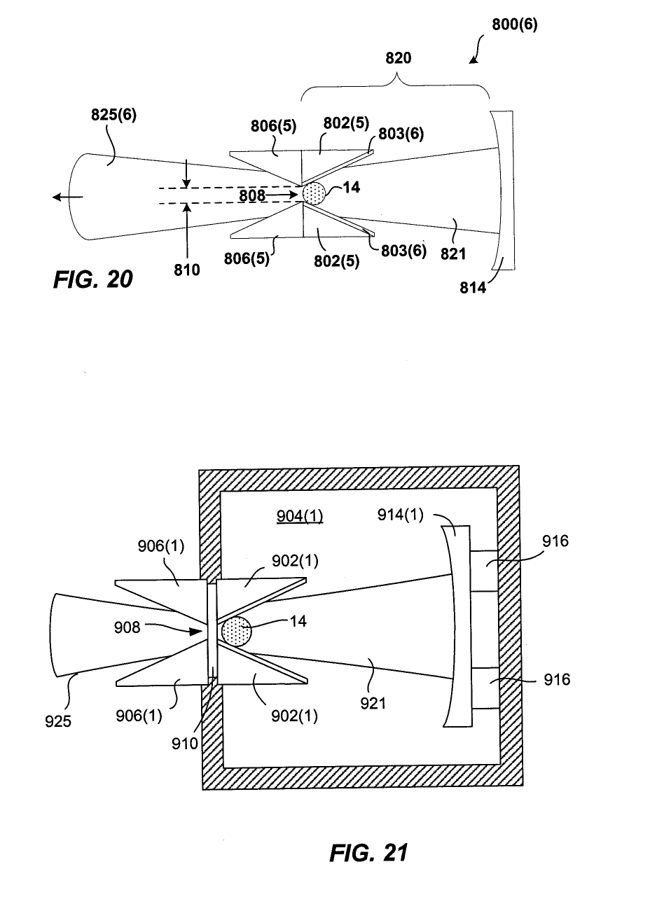

FIG. 20 shows a dual grating horn configuration 800(6) that includes a first horn 802(5) and a second horn 806(5). Configuration 800(6) is like configuration 800(1) (see FIG. 15), except that (a) first horn 802(5) and an associated grating 803(6) are configured so that terahertz radiation generated within horn 802(5) is in a radiative mode, and (2) a mirror 814 is added to the configuration. In configuration 800(6), first horn 802(5) forms one side of a resonant cavity 820 while mirror 814 forms another side of the resonant cavity. Similar to configurations 800(1), 800(4) and 800(5), electron beam 14 passes adjacent to grating 803(6) generating terahertz radiation, now labeled 821. However, in configuration 800(6), radiation 821 resonates within resonant cavity 820. A portion of radiation 821 may propagate from first horn 802(5) into second horn 806(5) through a gap 808; similarly to configuration 800(1), an intensity of electromagnetic radiation propagating into second horn 806(5) depends on a width 810 of gap 808, and on a surface profile of second horn 806(5) (and as noted in connection with FIG. 15, although shown as a planar horn, it is appreciated that second horn 806(5) may be ruled with a grating). Similarly to configuration 800(1), second horn 806 acts as an output coupler and forms a highly collimated (e.g., diffraction limited) beam 825(6), which may facilitate efficient coupling into instrumentation. Output coupling efficiency and cavity quality can be controlled in part, and tradeoffs therebetween facilitated, by adjusting width 810 and selecting the profile of grating 803(6). For example, widening width 810 will increase loss of radiation 821 from resonant cavity 820, decreasing a quality factor of cavity 820, but will increase output coupling of radiation 821 into beam 825(6). Therefore, in configuration 800(6), output coupling of beam 825(6) may be advantageously independent of cavity tuning (i.e., the relative positions of mirror 814 and horn 802(5)), and may be adjustable (by adjusting width 810). Resonance of radiation 821 within optical cavity 820 may serve to narrow a wavelength peak of radiation 821 and beam 825(6), much like the optical cavity of a semiconductor laser narrows a wavelength peak of light that would otherwise be emitted by a light-emitting diode within the laser.

It is understood that embodiments herein that utilize an electron beam require an evacuated chamber of some sort so that the electron beam can travel without disruption (e.g., by air molecules). Certain interactions between the terahertz radiation and matter are possible within such a chamber, or by arranging for the matter not to disrupt the evacuation of the chamber, but other interactions may require transmission of the terahertz radiation outside the chamber where it is generated. Below, embodiments are described that (a) generate and/or manipulate terahertz radiation in an evacuated chamber but pass the radiation out of the chamber, or (b) otherwise introduce matter without disrupting evacuation of a chamber such that terahertz radiation generated therein can interact with the matter.

FIGS. 21, 22A and 23 illustrate separation of two diametrically opposed horns 902, 906 by a window 910, which may for example be fabricated of optically thin mica. That is, a thickness of window 910 may be a small fraction of a wavelength of terahertz radiation, such that window 910 is transparent to the terahertz radiation without generating reflections.

In FIG. 21, electron beam 14 is formed in a chamber 904(1) that is evacuated. Chamber 904(1) contains a first horn 902(1), a mirror 914(1) and mirror control actuators 916. Radiation 921 is confined within a resonant cavity bounded by horn 902(1) and mirror 914(1), except that radiation in the form of a beam 925 can exit from first horn 902(1) through window 910 that bounds a gap 908, to a second horn 906(1), which is outside of chamber 904(1). Losses due to window 910 are minimal if second horn 906(1) is excited in an antisymmetrical mode relative to first horn 906(1), so that a field null exists at window 910 within gap 908. That is, any field present across window 910 will result in resistive losses as electrons are moved by the field within the material of window 910, so if a field null exists, such resistive losses are negligible. Similar to configuration 800(6) shown in FIG. 20, resonance of terahertz radiation 921 within chamber 904(1) serves to narrow a wavelength peak of radiation 921 and beam 925. Mirror control actuators 916 may be utilized to adjust a position of mirror 914(1) relative to horn 902(1), thereby tuning the resonant cavity. For example, mirror control actuators 916 may adjust mirror 914(1) such that radiation 921 is in resonance between mirror 914(1) and first horn 902(1), and/or to adjust positions of field maxima and field nulls within the resonant cavity and/or at window 910.

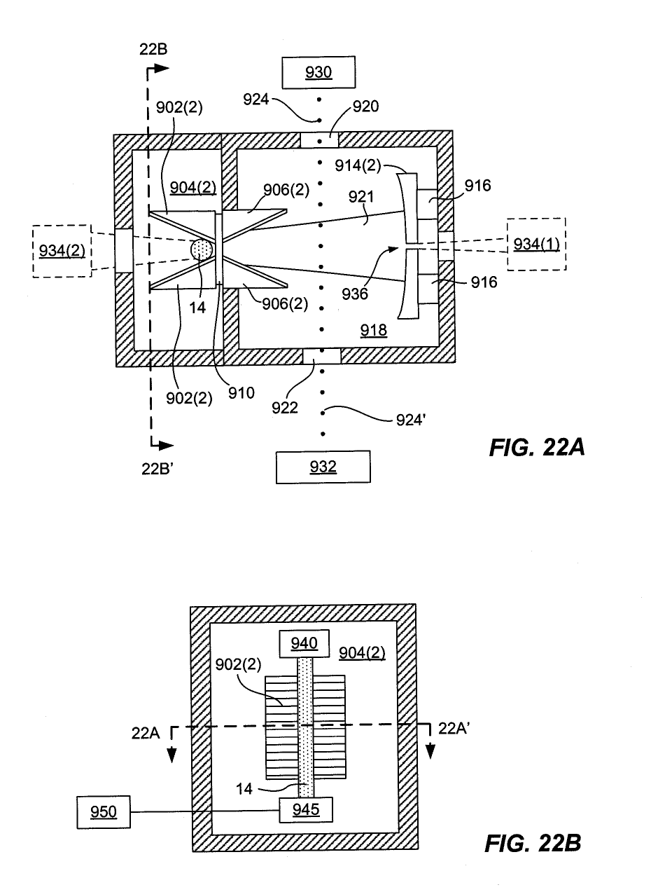

FIG. 22A shows a schematic cross-sectional view of a backward wave oscillator including two diametrically opposed optical horns 902(2), 906(2) and configured as an intracavity absorption spectrometer. Electron beam 14 is formed in a first (evacuated) chamber 904(2). A schematic cross-sectional view of first chamber 904(2) taken along line 22B-22B′ is shown in FIG. 22B. First chamber 904(2) contains a first grating horn 902(2). Terahertz radiation generated by electron beam 14 interacting with grating horn 902(2) passes through a window 910 and resonates between a second horn 906(2) and mirror 914(2), which is disposed in a second chamber 918. Second chamber 918 is not necessarily evacuated (the vacuum within chamber 904(2) is maintained by window 910), and allows a sample material 924 to enter from a source 930 through an inlet 920, pass through radiation 921 and exit as an irradiated material 924′ through an outlet 922, in order to observe interaction between materials 924, 924′ and radiation 921. Such interaction may be observed, for example, by a detector 932 that detects material 924′ in a transformed or excited state as compared to material 924. Interaction of radiation 921 with material 924 may, alternatively, be observed by detecting changes in radiation 921, as monitored by optional detectors 934(1) and/or 934(2). Detector 934(1) receives a portion of radiation 921 through a hole 936 formed in mirror 914(2), as shown, and can detect a change therein. Detector 934(2) receives a portion of terahertz radiation emitted from its source in chamber 904(2). It is appreciated that changes in radiation 921 might also be measured in other ways, for example by obtaining a sample of radiation 921 at a detector within chamber 904(2).

FIG. 22B shows a schematic cross-sectional view of first chamber 904(2) of FIG. 22A. Line 22A-22A′ in FIG. 22B denotes the view shown in FIG. 22A. FIG. 22B shows an electron source 940 that generates electron beam 14, which is received by electron beam collector 945. Collector 945 generates a signal that is passed to current monitor 950 in response to current of electron beam 14. Monitor 950 evaluates power (and accordingly, changes to power) in electron beam 14. Referring back to FIG. 22A, an interaction of material 924 with radiation 921 may cause changes in power of electron beam 14. Information about the interaction of material 924 with radiation may therefore be determined from such changes in power, as evaluated by monitor 950. A method of measuring the electron beam current is described in L. A. Surin, et al., Millimeter-wave intracavity-jet Orotron-spectrometer for investigation of van der Walls complexes, Rev. of Sci. Instr. 72, 2535 (2001). It is appreciated that the techniques disclosed for observing interaction between material 924 and radiation 921 are not exclusive of one another; more than one such technique (e.g., detecting material 924′, observing a change in a further portion of radiation 921 at either of detectors 934(1) and 934(2), or monitoring changes in electron beam 14 power at collector 945) may be utilized to extract different types of information about such interaction.

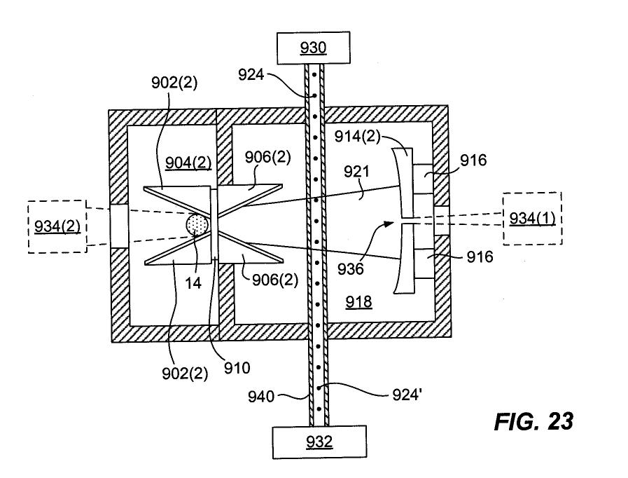

FIG. 23 shows a schematic cross-sectional view of another backward wave oscillator containing two diametrically opposed optical horns 902(2), 906(2) and configured as an absorption spectrometer. The elements of FIG. 23 are the same as those of FIG. 22A except that inlet 920 and outlet 922 are replaced by a tube 940 that carries a material being examined from source 930 to detector 932. Use of tube 940 may be advantageous in that interior walls of chamber 918 are not exposed to material 924, 924′ so that cross contamination of materials 924, 924′ is easier to control and the system is easier to maintain. Like window 910, tube 940 is formed of material that is optically thin compared to a wavelength of terahertz radiation 921 and may be positioned so that walls of tube 940 are positioned at field nulls, to minimize resistive losses. Also, it is appreciated that geometry of tube 940 may vary from that shown in FIG. 23, for example to maximize exposure of material 924, 924′ to terahertz radiation 921.

Certain changes may be made in the above methods, systems and devices without departing from the scope hereof. For example, it is appreciated that one skilled in the relevant arts will understand how to manipulate grating periods and electron velocity such that grating horns form bound or radiative modes respectively. Additional optical horns with or without gratings may be added to the configurations shown to capture and/or further manipulate terahertz radiation. It is to be noted that all matter contained in the above description or shown in the accompanying drawings is to be interpreted as illustrative and not in a limiting sense.

What is claimed is:

1. A system for generating terahertz radiation, comprising:
first and second optical horns, each of the first and second optical horns forming a gap at a respective vertex thereof,
the first optical horn being ruled with a grating period such that an electron beam interacting with the grating period produces the terahertz radiation,
the optical horns being diametrically opposed to one another such that the terahertz radiation exits the first horn and enters the second horn through the gaps.

2. The system of claim 1, wherein the second horn is planar such that radiation exiting the second horn forms a collimated free wave.

3. The system of claim 1, wherein the second horn is ruled with a second grating period, the grating period of the first horn and the grating period of the second horn oriented in phase such that radiation exiting the second horn forms Smith-Purcell radiation.

4. The system of claim 1, wherein the second horn contains an optical fiber, the terahertz radiation being coupled into the optical fiber through evanescent coupling.

5. The system of claim 4, the second horn being configured so as to form a bound mode of the terahertz radiation, to enhance the evanescent coupling into the fiber.

6. The system of claim 1, further comprising at least one chamber for isolating the first horn from the second horn.

7. The system of claim 6, wherein the chamber comprises a window such that the terahertz radiation enters the second horn through the window.

8. The system of claim 1, further comprising an electron source for generating the electron beam.

9. The system of claim 8, wherein (a) the electron source is responsive to a signal to vary a velocity of electrons of the electron beam in accordance with the signal, and (b) the system is configured to receive an input terahertz beam that establishes phase of the terahertz radiation within the resonant cavity, so that intensity of the terahertz radiation exiting the second horn is modulated in accordance with the signal.

10. The system of claim 1, further comprising one or more optical elements for focusing the terahertz radiation into a beam that exits the second horn.

11. The system of claim 10, at least one of the optical elements comprising a mirror, the first optical horn and the mirror forming a resonant cavity for the terahertz radiation.

12. The system of claim 11, wherein the mirror, the first optical horn and the second optical horn are configured to form the beam as a laser beam.

13. The system of claim 11, further comprising one or more mirror control actuators for adjusting a position of the mirror relative to the first optical horn, thereby tuning the resonant cavity.

14. A method for generating terahertz radiation, comprising:
generating an electron beam; and
focusing the electron beam adjacent a vertex of an optical horn that is ruled with a grating period such that interaction between the electron beam and the grating period produces the terahertz radiation.

15. The method of claim 14, further comprising coupling the terahertz radiation into an optical fiber.

16. The method of claim 14, further comprising focusing the terahertz radiation into a laser beam with one or more optical elements.

17. The method of claim 14, wherein focusing the terahertz radiation into a laser beam comprises:
facing a mirror towards an opening angle of the optical horn to form a resonant cavity therebetween for the terahertz radiation, and
tuning the resonant cavity by adjusting a position of the mirror with one or more mirror control actuators.

18. The method of claim 14, further comprising
modulating a velocity of electrons in the electron beam in accordance with an input signal, and
providing an input beam of terahertz radiation,
such that an intensity of the terahertz radiation is modulated in accordance with the input signal and is in phase with the input beam.

19. A method of evaluating interaction between a material and terahertz radiation, comprising:
generating the terahertz radiation by passing an electron beam adjacent to a vertex of a first optical horn such that the electron beam interacts with one or more gratings of the first optical horn to produce the terahertz radiation;
passing at least a portion of the terahertz radiation through a gap at the vertex of the first optical horn, into a corresponding gap at a vertex of a second optical horn, such that the portion of the terahertz radiation forms a terahertz radiation beam traveling outwardly from the vertex of the second optical horn;
passing a sample of the material through the terahertz radiation; and
measuring at least one of an effect of the terahertz radiation on the material and an effect of the material on the terahertz radiation.

20. Method of claim 19, wherein measuring comprises measuring an effect of the material on the terahertz radiation by sampling a further portion of the terahertz radiation beam and measuring a change in the further portion.

21. Method of claim 19, wherein measuring comprises measuring an effect of the material on the terahertz radiation by measuring a change in power of the electron beam.

22. Method of claim 19, wherein measuring comprises measuring an effect of the terahertz radiation on the material by detecting an excited state of the material after the material interacts with the terahertz radiation.
